(19) United States
(12) Patent Application Publication
(10) Pub. No.: US 2012/0148482 A1
(43) Pub. Date: Jun. 14, 2012

(54) METHOD FOR PRODUCING ULTRA-PURE AQUEOUS HYDROGEN PEROXIDE SOLUTION

(75) Inventors: Hui Tang, Shanghai (CN); Jiarong Zhan, Shanghai (CN)

(73) Assignee: Shanghai Huayi Microelectronic Material Co., Ltd., Shanghai (CN)

(21) Appl. No.: 12/982,771

(22) Filed: Dec. 30, 2010

(30) Foreign Application Priority Data
Dec. 8, 2010 (CN) 201010577193.9

(51) Int. Cl. C01B 15/013

(52) U.S. Cl. 423/584

(57) ABSTRACT

The present invention provides a method for continuous production of ultra-pure aqueous hydrogen peroxide solution. Industrial grade aqueous hydrogen peroxide solution as raw material is pretreated by macroporous adsorption resin, and then is brought into contact with a cation exchange resin, anion exchange resin to the first ion exchange. Then the material is brought into contact with multi-stage mixed cation and anion exchange resin columns, and is filtered by ultrafilter to obtain ultra-pure aqueous hydrogen peroxide solution. The method provided by the present invention has high security, simple operation, stable quality of product, and is suitable for continuously produce on a large scale.

### PRIORITY OF INVENTION

This application claims priority to Chinese Patent Application Number 201010577193.9 that was filed on 8 Dec. 2010. The entire content of this patent application is hereby incorporated herein by reference.

### FIELD OF THE INVENTION

The present invention relates to a method for producing the electronic grade reagent, and in particular it relates to a method for the continuous production of ultra-pure electronic grade aqueous hydrogen peroxide solution.

### BACKGROUND OF THE INVENTION

The electronic grade aqueous hydrogen peroxide solution is mainly used to clean and etch the large scale integrated circuit. With the development of the electronic industry, the integrated level of the integrated circuit becomes higher, and the requirement for the quality and purity of the electronic grade reagents such as aqueous hydrogen peroxide solution is more and more strict.

The industrial grade aqueous hydrogen peroxide solution is purified to the purity of reagent grade or food grade to be used as raw material in the conventional production of electronic grade aqueous hydrogen peroxide solution. However, there is not a method available for the production of ultra-pure aqueous hydrogen solution, which meets the SEMI C12 standard with industrial grade reagent as the raw material. Hence, for the conventional method, the cost for the raw material is high and economic efficiency is low.

The Rectification proceeding is the optimal method for removing the inorganic impurities. And it can achieve the high yield and can be used for long production cycle. The methods for producing the aqueous hydrogen peroxide solution disclosed by both patent JP11292521(A) and JP2000001305(A) use the multilevel heating and evaporation to execute gas-liquid separation. US patent US005670028A has disclosed a process for preparing high purity hydrogen peroxide aqueous solution, which includes the steps of distillation to remove the organic carbon impurities and inorganic impurities and then vacuum rectification is executed to the aqueous hydrogen peroxide solution. US patent US005296104A has disclosed a process for obtaining purified aqueous hydrogen peroxide solutions through the combination of rectification and washing. But, as we know, the energy consumption is high and cost is also high because of the use of lots of fluororesin as inner lining in the rectification tower.

The membrane separation with a promising prospect can be operated at room temperature and without phase transformation during the production. Although the method possess the advantages of simple operation and the product with high purity, the operating life of the membrane is short and cost is high because of the frequent replacement of the membrane. Therefore, this method is mostly used combined with other methods. Both the Chinese patent CN1189387C which has disclosed a method for producing high purity hydrogen peroxide and CN100420625C which has disclosed a method for producing electronic grade hydrogen peroxide through the combination of the ion exchanging resin and the membrane filtration. And Chinese patent CN101244810A has disclosed a method and an equipment for producing ultra-clean and high-purity hydrogen peroxide through the combination of the membrane filtration, the absorbent charcoal and the multi-stage rectification.

Supercritical Fluid Extraction, for example, is applied by Kemirachemical Oy Company locates in Finland to removing organic impurities and producing hydrogen peroxide. It is a newly developed method and advantaged in the simple operation, high yield and low energy consumption. However, the purity of the product achieved through this method is low.

There is also a method using of the Absorbent Charcoal for producing electronic grade aqueous hydrogen peroxide solution. Such as the method disclosed in Japanese patent JP11035305(A) for the production of purified aqueous hydrogen peroxide solution. However, the charcoal will decompose the hydrogen peroxide during the procedure.

The Resin Adsorption used to produce the ultra-clean and high-purity aqueous hydrogen peroxide solution relates mostly to strong-acid cation exchange resin, strong-basic anion exchange resin and hydrophilic porous resin etc. And this method achieves the high efficiency in removing the impurities, low occupation of land, smart equipment combination and it can obtain product with different purities. PCT patent WO98/54085A1 has disclosed a method for preparing an ultra-pure hydrogen peroxide solution by ion exchange in the present of ion acetate comprises at least cation-exchanging adsorbents and at least anion-exchanging adsorbents containing carboxylate ions of formula R—COO⁻ and, particularly, acetate ions. In the process for preparing the high purity hydrogen peroxide disclosed in U.S. Pat. No. 5,055,286, the hydrogen peroxide is purified through an anion exchange resin with a chelating agent adsorbed therein. U.S. Pat. No. 499,179 has disclosed a method for purifying an impure aqueous hydrogen peroxide solution comprises passing through a cation exchange resin layer and an anion exchange resin layer, and the halogen-containing porous resin layer between the above layers. Chinese paten CN1171776C has disclosed a method for the production of aqueous hydrogen peroxide solution comprising four ion exchanges of H⁺ cation exchange resin, F⁻ anion exchange resin, CO₃²⁻ or HCO₃⁻ anion exchange resin, and another H⁺ cation exchange resin.

The strong acid cation exchange resins, the strong basic anion exchange resins and the hydrophilic porous resins etc. are mostly used in the ion exchange method for producing ultra-pure aqueous hydrogen peroxide solution. However, the hydrogen peroxide is explosive and affected greatly by the factors, such as temperature, sequence of ion exchange resins etc., during production. And the framework of the resins are destroyed easily by the hydrogen peroxide possessing the strong oxidability and the decomposition in alkali. And it will lead to the loss of purifying capacity, lots of impurities such as organic peroxide and epoxide etc. generated and even the explosion may occur. The industrial grade aqueous hydrogen peroxide solution produced by Anthraquinone method (AQ) contains great many organic and inorganic impurities so that the aqueous hydrogen peroxide solution purified by simple connection or combination of anion exchange resin and cation exchange resin columns does not meet the SEMI C12 standard.

### SUMMARY OF THE INVENTION

The present invention provides a method for producing ultra-pure aqueous hydrogen peroxide solution with industrial grade aqueous hydrogen peroxide solution as raw material comprising pretreatment by macroporous adsorption resin and ion exchange resins to obtain ultra-pure aqueous hydrogen peroxide solution which has stable quality and meets the SEMI C12 standard.

The method in the present invention has the following steps:

The raw material of industrial grade aqueous hydrogen peroxide solution is pretreated by being brought contact with macroporous adsorption resin to control the content of organic impurities (as organic carbon) being ≦20 ppm. The material is cooled and brought contact in order with cation exchange resin column, anion exchange resin column, and multi-stage (two-stage prefer) mixed cation and anion exchange resin columns, and filtered by perfluoromaterial membrane ultrafilter to obtain the ultra-pure aqueous hydrogen peroxide solution.

The temperature is controlled within 5-20° C. during the above process. And in the macroporous adsorption resin and the ion exchange resin columns, fluororesin is coated on the intines and internals are fitted to protect the resins and columns.

Preferably, the aqueous hydrogen peroxide solution's flow rate through the ion exchange resin columns is 200-400 kg/h.

The material of the macroporous resin is preferred to be polystyrene, polydivinylbenzene, or their mixture.

Preferably, the weight ratio between the anion exchange resin and cation exchange resin in the mixed cation and anion exchange resin column is 1:1-1:2.

More preferably, the slenderness ratio of the ion exchange resin column is 8:1-10:1.

Preferably, the rangeability of the temperature in the ion exchange resin columns is ≦5° C.

Preferably, the caiton exchange resin is strong acid cation exchange resin and the anion exchange resin is strong basic anion exchange resin.

Preferably, the aperture of the perfluoromaterial membrane is 0.1 μm.

The perfluoro-material (all H atoms of which linked to C atoms are replaced by F atoms) can be polytetrafluoroethylene, polyhexafluoropropylene, fluorinated ethylene propylene copolymer, Polyfluoroalkoxy (i.e. PFA, tetrafluoroethylene-perfluoroalkoxy vinyl ether copolymer), etc.

The method for continuous production of ultra-pure aqueous hydrogen peroxide solution in present invention has mild process condition and has perfluoro-material membrane fitted on the adsorption resin and ion exchange resin columns to reduce the damage and wastage result as a result of the damage, and so can protect the resins. The suitable built-up sequence of adsorption resin column and the ion exchange resin columns makes greatest efficiency of adsorption resin and ion exchange resins. And the impurities ions such as Fe, Al, Cr, P, Sn can be removed effectively by the perfluoro-material membrane.

Based on the above techniques, the method for continuous producing of ultra-pure aqueous hydrogen peroxide solution overcomes the defects of the prior arts such as poor continuity, no guarantee of security, poor and instability quality of product, etc. And the present invention possesses the simple equipment, the high-usage of rooms, the safe operation, and it is also a suitable continuous production on a large scale. The ultra-pure aqueous hydrogen peroxide solution produced by the present invention has the content of organic carbon of lower than 20 ppm, single cation of lower than 0.1 ppb, single anion of lower than 30 ppb, bigger than 0.5 μm particles of lower than 25 pcs/ml, and meets the SEMI C12 standard.

### BRIEF DESCRIPTION OF THE DRAWINGS

FIG. 1 illustrates the process of the method of the present invention, in which sign 1 is pump; sign 2 is macroporous adsorption column; sign 3 is cation exchange resin column; sign 4 is anion exchange resin column; sign 5 is cooler; sign 6 and 7 are mixed cation and anion exchange resin columns; sign 8 is membrane filter; sign 9 is sampling location; sign 10 is product reservoir; sign 11 is raw material.

### DETAILED DESCRIPTION OF THE INVENTION

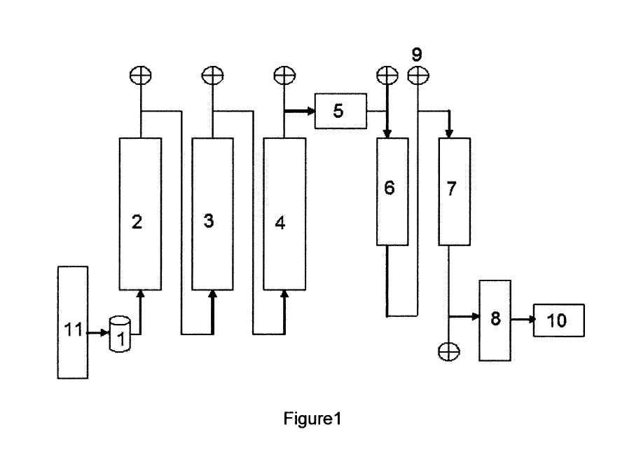

In conjunction with FIG. 1, the method for producing the ultra-pure aqueous hydrogen solution in the present invention, industrial grade hydrogen peroxide is used as raw material, and it comprises the pretreatment by being brought contact with the macroporous adsorption resin to control the content of organic impurities (as organic carbon) in the raw material being ≦20 ppm. And then the adsorptions by cation exchange resin column, anion exchange resin column, and multi-stage mixed cation and anion exchange resin columns are executed. At last, the ultrafiltration by perfluoromaterial membrane is processed to obtain ultra-pure aqueous hydrogen solution.

The temperature about the above production is controlled in 5-20° C., and the rangeability of the temperature in the ion exchange resin columns is ≦5° C. The flow rate of the hydrogen peroxide solution through ion exchange resin columns can be more than 200 kg/h because of the mild process condition and high security.

The perfluoro-material membrane is fitted on the adsorption column and the ion exchange resin columns (the slenderness ratio is 8:1-10:1), and the resin can be protected due to the anticorrosion and good chemical stability features of the perfluoro-material.

A better understanding of the present invention is obtained when the following non-limiting detailed description is considered.

### Embodiment 1

The temperature is controlled at 5° C., the industrial grade aqueous hydrogen peroxide solution of 30 wt % is brought into contact with the macroporous adsorption resin column at the flow rate of 200 kg/h for the pretreatment and to reduce the content of organic impurities (as organic carbon) to less than 200 ppm. And then the solution is cooled.

Under the same condition, the aqueous hydrogen peroxide solution pretreated is brought into contact with strong acid cation exchange resin column and strong basic anion exchange resin column in order. The aqueous hydrogen peroxide solution after ion exchange is brought into contact with mixed cation and anion exchange resin columns the volume ratio between cation and anion resin of in which is 1:1 to two times of ion exchange.

The temperature is maintained within 5-20° C., the aqueous hydrogen peroxide solution after the two times of ion of exchange is delivered into the polytetrafluoroethylene hyperfitration membrane which aperture is 0.1 μm after Control Analysis. After filtering, the purity of the aqueous hydrogen peroxide solution is tested and the results are list in Table 1.

### Embodiment 2

The temperature is controlled at 5° C., the industrial grade aqueous hydrogen peroxide solution of 30 wt % is brought into contact with the macroporous adsorption resin column at the flow rate of 300 kg/h for the pretreatment and to reduce the content of organic impurities (as organic carbon) to less than 200 ppm. And then the solution is cooled.

With reference to Embodiment 1, the aqueous hydrogen peroxide solution pretreated is brought into contact with strong acid cation exchange resin column and strong basic anion exchange resin column in order. The aqueous hydrogen peroxide solution after ion exchange is brought into contact with mixed cation and anion exchange resin columns the volume ratio between cation and anion resin of in which is 1:1.5 for the two times of ion exchange.

The temperature is maintained within 5-20° C., the aqueous hydrogen peroxide solution after the two times of ion of exchange is delivered into the polytetrafluoroethylene hyperfitration membrane which aperture is 0.1 μm after Control Analysis. After filtering, the purity of the aqueous hydrogen peroxide solution is tested and the results are list in Table 1.

### Embodiment 3

The temperature is controlled at 5° C., the industrial grade aqueous hydrogen peroxide solution of 30 wt % is brought into contact with the macroporous adsorption resin column at the flow rate of 400 kg/h for the pretreatment and to reduce the content of organic impurities (as organic carbon) to less than 200 ppm. And then the solution is cooled.

With reference to Embodiment 1, the aqueous hydrogen peroxide solution pretreated is brought into contact with strong acid cation exchange resin column and strong basic anion exchange resin column in order. The aqueous hydrogen peroxide solution after ion exchange is brought into contact with mixed cation and anion exchange resin columns the volume ratio between cation and anion resin of in which is 1:2 to two times of ion exchange.

The temperature is maintained within 5-20° C., the aqueous hydrogen peroxide solution after the two times of ion of exchange is delivered into the polytetrafluoroethylene hyperfitration membrane which aperture is 0.1 μm after Control Analysis. After filtering, the purity of the aqueous hydrogen peroxide solution is tested and the results are list in Table 1.

TABLE 1
purity testing results of the product of Embodiment 1-3

| Item | U.M. | SEMI C12 | Emb. 1 | Emb. 2 | Em.3 |
|---|---|---|---|---|---|
| Assay(H₂O₂) | % | 30-32 | 32 | 32 | 32 |
| Color(APHA) | APHA | — | 6 | 6 | 6 |
| Free Acid | ueq/g | — | 0.6 | 0.6 | 0.6 |
| Total Organic | ppm | — | <15 | <15 | <15 |
| Carbon(TOC) | | | | | |
| Chloride(Cl) | ppm | 0.03 | <0.03 | <0.03 | <0.03 |
| Phosphate(PO₄) | ppb | 30 | <10 | <10 | <10 |
| Sulfate(SO₄) | ppb | 30 | <10 | <10 | <10 |
| Aluminum(Al) | ppb | 0.1 | <0.1 | <0.1 | <0.1 |
| Antimony(Sb) | ppb | 0.1 | <0.1 | <0.1 | <0.1 |
| Arsenic(As) | ppb | 0.1 | <0.1 | <0.1 | <0.1 |
| Antimony and | ppb | — | <0.1 | <0.1 | <0.1 |
| Arsenic (as Arsenic) | | | | | |
| Barium(Ba) | ppb | 0.1 | <0.1 | <0.1 | <0.1 |
| Boron(B) | ppb | 0.1 | <0.1 | <0.1 | <0.1 |
| Cadmium(Cd) | ppb | 0.1 | <0.1 | <0.1 | <0.1 |
| Calcium(Ca) | ppb | 0.1 | <0.1 | <0.1 | <0.1 |
| Chromium(Cr) | ppb | 0.1 | <0.1 | <0.1 | <0.1 |
| Cobalt(Co) | ppb | — | <0.1 | <0.1 | <0.1 |
| Copper(Cu) | ppb | 0.1 | <0.1 | <0.1 | <0.1 |
| Gallium(Ga) | ppb | — | <0.1 | <0.1 | <0.1 |
| Germanium(Ge) | ppb | — | <0.1 | <0.1 | <0.1 |
| Gold(Au) | ppb | — | <0.1 | <0.1 | <0.1 |
| Iron(Fe) | ppb | 0.1 | <0.1 | <0.1 | <0.1 |
| Lead(Pb) | ppb | 0.1 | <0.1 | <0.1 | <0.1 |
| Lithium(Li) | ppb | 0.1 | <0.1 | <0.1 | <0.1 |
| Magnesium(Mg) | ppb | 0.1 | <0.1 | <0.1 | <0.1 |
| Manganese(Mn) | ppb | 0.1 | <0.1 | <0.1 | <0.1 |
| Molybdenum(Mo) | ppb | — | <0.1 | <0.1 | <0.1 |
| Nickel(Ni) | ppb | 0.1 | <0.1 | <0.1 | <0.1 |
| Niobium(Nb) | ppb | — | <0.1 | <0.1 | <0.1 |
| Potassium(K) | ppb | 0.1 | <0.1 | <0.1 | <0.1 |
| Silver(Ag) | ppb | — | <0.1 | <0.1 | <0.1 |
| Sodium(Na) | ppb | 0.1 | <0.1 | <0.1 | <0.1 |
| Strontium(Sr) | ppb | — | <0.1 | <0.1 | <0.1 |
| Tin(Sn) | ppb | 0.1 | <0.1 | <0.1 | <0.1 |
| Titanium(Ti) | ppb | 0.1 | <0.1 | <0.1 | <0.1 |
| Vanadium(V) | ppb | 0.1 | <0.1 | <0.1 | <0.1 |
| Zinic(Zn) | ppb | 0.1 | <0.1 | <0.1 | <0.1 |
| ≧0.5 μm particles | pcs/ml | — | <150 | <150 | <150 |

Wherein, the content of hydrogen peroxide is tested by Chemical Analysis, organic carbon by Total Organic Carbon (TOC) Analyzer (TOC-V_{CPH}), cations by ICP-MS, anions by Ion Exchange Chromatography (IC), and particles of ≦0.5 μm by Laser Particle Counter (RION 40KAF).

According to the Table 1, we can see that the aqueous hydrogen peroxide solution produced by the method of the present invention has stable quality and meets the SEMI C12 standard.

It will be appreciated that the description of the embodiments above is only the illustrations of application, and doesn't limit the invention to the specific embodiments illustrated. Numerous other ways of carrying out the method provided by the present invention may be devised by a person skilled in the art without departing from the scope of the invention, and are thus encompassed by the present invention. So that it should be understood that any identical shifting can be done without departing from the scope of the present invention.

1. A method for producing ultra-pure aqueous hydrogen peroxide solution, characterized in that the method includes following steps:
the raw material of industrial grade aqueous hydrogen peroxide solution is brought into contact with a macroporous adsorption resin to be pretreated and to control the content of organic impurities as organic carbon being ≦20 ppm; the material is cooled and brought into contact with cation-exchange resin column, anion-exchange resin column and two-stage mixed cation and anion exchange resin column, and it is filtered by a perfluoro-material membrane ultrafilter to obtain the ultra-pure aqueous hydrogen peroxide solution;
the temperature during production is controlled within 5-20° C.; in the macroporous adsorption resin and the ion exchange resin columns, fluororesin are coated on the intines and fitted internally.

2. A method according to claim 1, characterized in that the material of the macroporous resin is polystyrene, polydivinylbenzene, or their mixture.

3. A method according to claim 1, characterized in that the weight ratio between the anion exchange resin and cation exchange resin in the mixed cation and anion exchange resin column is 1:1-1:2.

4. A method according to claim for 3, characterized in that the slenderness ratio of the ion exchange resin column is 8:1-10:1.

5. A method according to claim 4, characterized in that the caiton exchange resin is strong acid cation exchange resin and the anion exchange resin is strong basic anion exchange resin.

6. A method according to claim 1, characterized in that the aperture of the perfluoromaterial membrane is 0.1 μm.

7. A method according to claim 1, characterized in that the rangeability of the temperature in the ion exchange resin columns is ≦5° C.

8. A method according to claim 1, characterized in that the aqueous hydrogen peroxide solution's flow rate through the ion exchange resin columns is 200-400 kg/h.
